(19) United States
(12) Patent Application Publication
(10) Pub. No.: US 2008/0186169 A1
(43) Pub. Date: Aug. 7, 2008

(54) Operation signal generation device

(75) Inventor: Kazuo Kawaguchi, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/010,970

(22) Filed: Jan. 31, 2008

(30) Foreign Application Priority Data
Feb. 1, 2007 (JP) 2007-023315
Apr. 13, 2007 (JP) 2007-105558
Sep. 18, 2007 (JP) 2007-241001
Nov. 26, 2007 (JP) 2007-304534

(51) Int. Cl. G08B 21/00

(52) U.S. Cl. 340/540

(57) ABSTRACT

An operation signal generation device generating an operation signal for operating an electronic instrument. The operation signal generation device includes: a vibration detection sensor which detects vibrations of a building, a constructed product secured on a building, or a stationary article; and an operation signal generation section which determines whether or not an output signal from the vibration detection sensor satisfies a predetermined condition, and generates the operation signal when the output signal satisfies the predetermined condition.

Japanese Patent Application No. 2007-105558, filed on Apr. 13, 2007, Japanese Patent Application No. 2007-23315, filed on Feb. 1, 2007, Japanese Patent Application No. 2007-241001, filed on Sep. 18, 2007, and Japanese Patent Application No. 2007-304534, filed on Nov. 26, 2007, are hereby incorporated by reference in their entirety.

### BACKGROUND OF THE INVENTION

The present invention relates to an operation signal generation device.

An operation signal generation device is known which includes an information input device to which the user inputs information, and generates an operation signal which operates an electronic instrument based on operation information input to the information input device. As the information input device for the user to input the operation information to the operation signal generation device, an information input device having a mechanical mechanism (e.g., push button) and an information input device such as a touch panel are known. A switch which ON-OFF-controls an electronic instrument using a mechanical mechanism is also known.

An information input device having a mechanical mechanism (e.g., push button) may deteriorate due to an external factor such as dust. Moreover, it is difficult to install such an information input device in a place where water is used since a short circuit may occur. It is also difficult to install such an information input device in a flammable place since a spark may occur during operation. Since information input device having a mechanical mechanism produces elevations or depressions on the installation surface, the installation place may be limited from the viewpoint of appearance.

A touch panel is known as an information input device which does not have elevations or depressions on the surface. However it is difficult to dispose a touch panel in a place where water is used due to its mechanism. Moreover, the installation place may be limited from the viewpoint of the rigidity of the panel surface.

### SUMMARY

According to one aspect of the invention, there is provided an operation signal generation device generating an operation signal for operating an electronic instrument, the operation signal generation device comprising:

a vibration detection sensor which detects vibrations of a building, a constructed product secured on a building, or a stationary article; and

an operation signal generation section which determines whether or not an output signal from the vibration detection sensor satisfies a predetermined condition, and generates the operation signal when the output signal satisfies the predetermined condition.

### BRIEF DESCRIPTION OF THE SEVERAL VIEWS OF THE DRAWING

FIG. 1 is a diagram illustrative of an operation signal generation device.

FIG. 2A and FIG. 2B are diagrams illustrative of the operation signal generation device.

FIG. 3 is a diagram illustrative of the operation signal generation device.

FIG. 4A and FIG. 4B are diagrams illustrative of the operation signal generation device.

FIG. 5A and FIG. 5B are diagrams illustrative of the operation signal generation device.

FIG. 6A and FIG. 6B are diagrams illustrative of the operation signal generation device.

FIG. 7 is a table for describing the operation signal generation device.

FIG. 8 is a diagram illustrative of the operation signal generation device.

FIG. 9 is a flowchart illustrative of a process which determines a hit count.

FIG. 10 is a flowchart illustrative of a process which registers the correspondence relationship between a hit count and an operation signal.

FIG. 11 is a flowchart illustrative of a process which registers a determination condition.

FIG. 12 is a flowchart illustrative of a process which determines a hit count.

FIG. 13 is a flowchart illustrative of the operation of an operation signal generation device.

FIG. 14 is a diagram showing another example in which an operation signal generation device unit is installed in a holding member.

FIG. 15 is a diagram showing a further example in which an operation signal generation device unit is installed in a holding member.

FIG. 16 shows a configuration example of an operation signal generation device unit 2.

FIG. 17 shows another configuration example of an operation signal generation device unit 2.

FIG. 18 is a diagram showing the positional relationship between a plurality of switch areas and a gyrosensor provided in a building.

FIGS. 19A and 19B are diagrams showing examples of an analog signal output from a gyrosensor when hitting each switch area.

FIG. 20 is a diagram showing the positional relationship between a plurality of switch areas and a gyrosensor provided in a building.

FIGS. 21A to 21C are diagrams showing examples of an analog signal output from a gyrosensor when hitting each switch area.

FIG. 22 is a diagram showing the positional relationship between a plurality of switch areas and a plurality of gyrosensors provided on a flat surface of a building.

FIGS. 23A to 23D are diagrams showing examples of analog signals output from a plurality of gyrosensors when hitting each switch area.

FIG. 24 is a diagram showing the positional relationship between four switch areas and two gyrosensors provided on a flat surface of a building.

FIGS. 25A to 25D are diagrams showing examples of analog signals output from a plurality of gyrosensors when hitting each switch area.

FIG. 26 is a flowchart illustrative of the flow of a process which determines the presence or absence of a hit input using a building utilizing a rotational angular velocity.

### DETAILED DESCRIPTION OF THE EMBODIMENT

The invention may provide an operation signal generation device which enables an information input device to be arbitrarily installed.

(1) According to one embodiment of the invention, there is provided an operation signal generation device generating an operation signal for operating an electronic instrument, the operation signal generation device comprising:

a vibration detection sensor which detects vibrations of a building, a constructed product secured on a building, or a stationary article; and

an operation signal generation section which determines whether or not an output signal from the vibration detection sensor satisfies a predetermined condition, and generates the operation signal when the output signal satisfies the predetermined condition.

According to this embodiment, the operation signal which operates the electronic instrument is generated based on the output signal (vibrations detected by the vibration detection sensor) from the vibration detection sensor. Since the vibration detection sensor is configured to detect vibrations of a building or the like, the operation signal generation section generates the operation signal based on the vibration state of the building or the like. Specifically, the operation signal generation device according to this embodiment generates the operation signal which operates the electronic instrument when the user vibrates a building or the like.

According to the this embodiment, an operation signal generation device with excellent operability can be provided which allows the user to generate the operation signal by merely vibrating a building or the like without operating an operation section such as a button or a key.

Moreover, the operation signal generation device according to this embodiment allows the user to operate an electronic instrument without operating an operation section. Therefore, according to the this embodiment, an operation section need not be formed so that the user can identify the operation section. Specifically, since the operation section need not be observed by the used, an operation signal generation device can be provided which can be disposed in a building or the like without limitations to the appearance.

(2) The operation signal generation device may further comprise a holding member which holds the vibration detection sensor and is able to function as part of the building, the constructed product, or the article.

Vibrations of a building or the like can be accurately detected by installing the vibration detection sensor in the member (holding member) which forms a building or the like. Note that the vibration detection sensor which may be applied to this embodiment is not limited to a vibration detection sensor with a specific configuration. A known vibration detection sensor may also be applied. As the vibration detection sensor, an angular velocity sensor (gyrosensor) or an acceleration sensor may be utilized.

(3) In this operation signal generation device,

a main surface of the holding member may have a vibration input area; and

the vibration input area and a peripheral area of the vibration input area on the main surface may be formed flat.

The vibration input area may be appropriately set on the main surface (surface which faces the user) of the holding member. For example, the vibration input area may be set in an area of the main surface in which vibrations (hit vibrations of the holding member which occur when hitting the holding member) input to the holding member by the user are most accurately transmitted to the vibration detection sensor. The vibration input area may be an area which overlaps the vibration detection sensor (operation signal generation device unit).

(4) In this operation signal generation device, the holding member may engage with an opening of a depression formed in the building, the constructed product, or the article so that the holding member is integrated with the building, the constructed product, or the article, an outer surface of the holding member serving as a vibration input area.

According to this configuration, when the operation signal generation device is fitted into the opening of the depression, the outer surface of the operation signal generation device is integrated with the building, the constructed product, or the article to form the vibration input area.

(5) In this operation signal generation device, a fluorescent coating may be at least partially applied to the vibration input area.

This makes it possible to allow the user to accurately observe the vibration input area in a dark place, whereby the user can accurately operate the electronic instrument.

(6) The operation signal generation device may further comprise a light-emitting component, the vibration input area at least partially transmitting light emitted from the light-emitting component.

This makes it possible to allow the user to accurately observe the vibration input area in a dark place, whereby the user can accurately operate the electronic instrument.

(7) The operation signal generation device may further comprise a board on which the vibration detection sensor is mounted, the board being disposed at an interval from the holding member.

(8) In this operation signal generation device, the board may be held by the holding member at one or more points.

According to this configuration, since vibrations of the holding member can be accurately transmitted to the vibration detection sensor, an operation signal generation device with high accuracy can be provided.

(9) In this operation signal generation device, the board may be held by the holding member through a resin member.

In this embodiment, the resin member may be selected depending on the operation accuracy required for the operation signal generation device. For example, the operation signal generation device can be configured to accurately respond to vibrations of the holding member when utilizing a hard resin member. On the other hand, since the vibration energy of the holding member can be absorbed by the resin member when utilizing a soft resin member, effects of vibrations with a small amplitude (energy) can be disregarded. Therefore, an operation signal generation device which rarely malfunctions can be provided.

(10) The operation signal generation device may further comprise a board on which the vibration detection sensor is mounted, the board being in contact with the holding member.

According to this configuration, since vibrations of the holding member can be accurately transmitted to the vibration detection sensor, an operation signal generation device with high accuracy can be provided.

(11) The operation signal generation device may further comprise a waterproof housing in which at least the vibration detection sensor is disposed.

According to this configuration, since the vibration detection sensor can be prevented from coming into contact with water, the vibration detection sensor can be disposed in a place where water is used.

(12) The operation signal generation device may further comprise an airtight housing in which at least the vibration detection sensor is disposed.

According to this configuration, the vibration detection sensor can be safely installed in a flammable place.

(13) The operation signal generation device may further comprise:

a determination condition storage section which stores the predetermined condition; and

a determination condition setting section which causes the determination condition storage section to store the predetermined condition based on the output signal from the vibration detection sensor.

When different users perform the same operation, vibrations produced may differ depending on the user. For example, the amplitude, the attenuation pattern, and the peak amplitude of vibrations detected by the vibration detection sensor may differ between users A and B even if the users A and B have performed the same operation.

The operation signal generation device may be designed to absorb the difference between users. On the other hand, an operation signal generation device with a security function can be provided utilizing the difference between users.

For example, if the determination condition is set based on the output signal from the vibration detection sensor when a specific user vibrates the vibration detection sensor, since it is difficult for another user to accurately reproduce the vibrations, a situation in which the electronic instrument is operated by another person can be prevented.

Moreover, since the determination condition can be set while taking the characteristics of the user into account, it is possible to accurate respond to vibrations produced by a specific user. Therefore, an operation signal generation device which rarely malfunctions can be provided.

(14) In this operation signal generation device, the operation signal generation section may determine whether or not a hit input is performed to the building, the constructed product, or the article based on the output signal from the vibration detection sensor, and generate the operation signal corresponding to the hit input when the operation signal generation section has determined that the hit input has been performed.

The hit input detection section may determine the switch area which has been hit based on a change in the rotational angular velocity value of one angular velocity sensor.

The rotation direction and the degree of rotation of the gyrosensor differ when hitting each switch area having a different positional relationship with the angular velocity sensor. Therefore, the characteristics (e.g., amplitude direction and amplitude) of the output signal of the gyrosensor also differ. Therefore, it is possible to determine the hit switch area based on the characteristics of the output signal from the gyrosensor.

Therefore, if different commands are respectively associated with the switch areas, a plurality of commands can be input using one angular velocity sensor.

(15) In this operation signal generation device,

the operation signal generation section may determine whether or not a hit input is performed to a plurality of switch areas respectively set at different positions of the vibration input area based on the output signal from the vibration detection sensor; and

when the operation signal generation section has determined that the hit input has been performed to a switch area among the switch areas, the operation signal generation section may generate the operation signal corresponding to the switch area.

The hit input detection section may determine the hit switch area based on a change in the rotational angular velocity value of a plurality of angular velocity sensors.

(16) In this operation signal generation device,

the operation signal generation section may determine whether or not a hit point is performed to a plurality of switch areas respectively set at different positions of the vibration input area based on change in output signals from a plurality of the vibration detection sensors respectively disposed at different positions of the holding member; and

when the operation signal generation section has determined that the hit input has been performed to a switch area among the switch areas, the operation signal generation section may generate the operation signal corresponding to the switch area.

(17) In this operation signal generation device, the operation signal generation section may include:

a hit count detection section detecting a hit count which is a number of hits at the building, the constructed product, or the article by a user based on the output signal from the vibration detection sensor; and

a correspondence relationship storage section storing a correspondence relationship between the hit count and the operation signal; and

the operation signal generation section may generate the operation signal corresponding to the hit count detected by the hit count detection section based on the correspondence relationship.

This makes it possible for the user to cause the electronic instrument to perform a desired operation by a simple operation of hitting a building or the like.

(18) The operation signal generation device may further comprise a correspondence relationship setting section which sets the correspondence relationship between the hit count and the operation signal and causes the correspondence relationship storage section to store the correspondence relationship.

This enables provision of an operation signal generation device optimum for the user's desired application.

(19) In this operation signal generation device,

the correspondence relationship storage section may store the correspondence relationship between the hit count and the operation signal in units of processing systems,

the operation signal generation device may further comprise a processing system switching section which selects a processing system from a plurality of processing systems; and

the operation signal generation section may generate the operation signal associated with the generated hit count based on the correspondence relationship in the selected processing system.

According to this configuration, since the user can cause the electronic instrument to perform various operations, an operation signal generation device with excellent operability can be provided.

(20) The operation signal generation device may further comprise a setting means which enables or disables an operation of the electronic instrument based on the output signal from the vibration detection sensor.

This makes it possible to prevent malfunction of the electronic instrument.

The term “setting means” used herein may be a contact detection section which detects contact with the user. The operation signal generation device may be configured to enable the operation of the electronic instrument based on the output signal from the vibration detection sensor only when the user contacts the contact detection section. As the contact detection section, a known device such as an electrostatic sensor, a pressure sensor, or a thermosensor may be utilized.

The embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

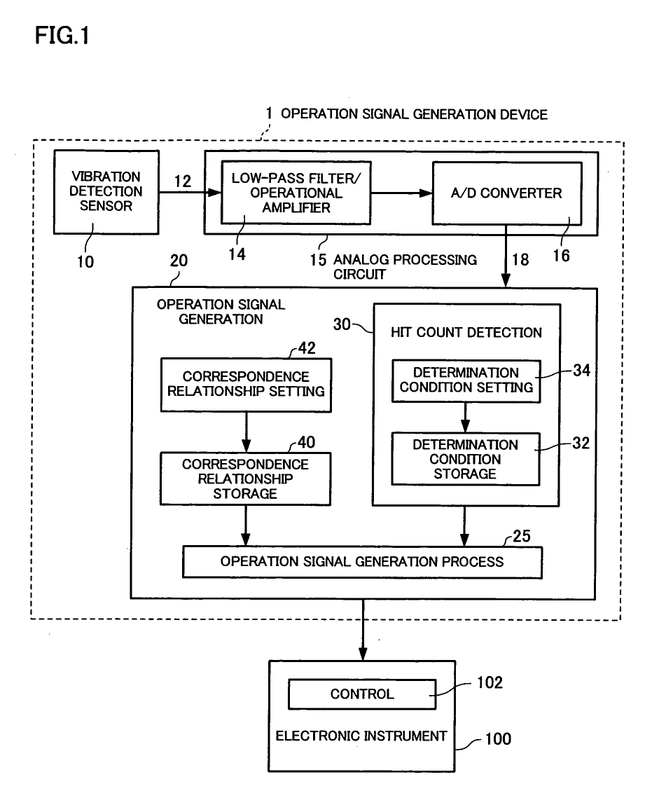

FIGS. 1 to 13 illustrate an operation signal generation device 1 according to one embodiment to which the invention is applied. The operation signal generation device 1 is a device which generates an operation signal which operates an electronic instrument based on vibrations of a building, a constructed product secured on a building, or a stationary article (hereinafter may be referred to as “building or the like”).

The term “building” used herein includes a house (including wall, floor, ceiling, roof, pillar, pool, bath, and the like), a building, a road (including pavement), a harbor facility, a dam, a water service/sewer, a pipeline, a ship, a train, an automobile, and a parking lot (including multistory parking garage). The term “constructed product secured on a building” used herein includes a door, a bathtub, a bath unit, a ventilator unit, a rest room unit, and a built-in kitchen installed in a house or the like, a utility pole, a transmission tower, and a manhole installed on a road. The term “stationary article” used herein includes a furniture such as a table, a chair, a bookshelf, or a closet, an electronic instrument main body and a remote controller (operation target) installed in a house or the like. Note that this embodiment is not limited to the above examples of the building, the constructed product, and the article. This embodiment also aims at members belonging to different categories such as a building and a constructed product, a constructed product and a stationary article, an stationary article and a building.

An electronic instrument which is the operation target according to this embodiment is not particularly limited. For example, the electronic instrument may be a lighting apparatus, an AV apparatus, an air conditioner, a navigation system, a door (automatic door), an electronic key, a ventilator, or a solenoid valve. Note that these electronic instruments are examples of the operation target according to this embodiment. This embodiment is not limited to these electronic instruments.

As shown FIG. 1, the operation signal generation device 1 according to this embodiment includes a vibration detection sensor 10 which detects vibrations. In this embodiment, an operation signal generation section 20 described later generates an operation signal which operates an electronic instrument based on an output signal from the vibration detection sensor 10. Therefore, the vibration detection sensor 10 according to this embodiment may be considered to an operation information input device (user interface) which inputs operation information to the operation signal generation device 1.

As the vibration detection sensor 10, an arbitrary sensor which can detect vibrations of an object (e.g., building) may be utilized. For example, an angular velocity sensor (gyrosensor) may be utilized as the vibration detection sensor 10. The angular velocity sensor is a sensor which measures a rotational velocity (rotational angular velocity) with respect to a rotational motion around a specific rotation axis. The angular velocity sensor may be configured to output an analog signal corresponding to the rotational angular velocity. The gyrosensor may be a vibrating gyroscope which vibrates utilizing a piezoelectric effect, for example. In this type of sensor, an alternating-current voltage is applied to an gyro-element (vibrator such as rock crystal) to cause the gyro-element to at least partially vibrate, and a current (voltage) corresponding to the rotation rate or the angular velocity is generated utilizing a Coriolis force. The gyrosensor amplifies the current (voltage) signal and outputs a voltage proportional to the angular velocity to output an electric signal corresponding to the vibrations. The type of gyrosensor is arbitrary. For example, a gyrosensor utilizing a microelectromechanical system (MEMS) technology may be used. The vibration detection sensor 10 may detect only vibrations in a predetermined single axis direction, or may detect vibrations in each of two or three axes which intersect perpendicularly.

Note that the vibration detection sensor 10 which may be applied to this embodiment is not limited to the gyrosensor. For example, an acceleration sensor which detects acceleration may be utilized as the vibration detection sensor 10. This also enables vibrations of a building or the like to be detected.

As shown FIG. 1, the operation signal generation device 1 according to this embodiment includes an analog processing circuit (analog front-end circuit) 15. The analog processing circuit 15 includes a low-pass filter/operational amplifier 14 and an A/D converter 16. The analog processing circuit 15 may receive an analog signal 12 output from the vibration detection sensor 10, and outputs a corresponding digital signal 18. In this embodiment, the analog processing circuit 15 may be considered to be part of the vibration detection sensor 10 or the operation signal generation section 20 described later. Note that the operation signal generation device 1 according to this embodiment may not include the analog processing circuit 15.

As shown FIG. 1, the operation signal generation device 1 according to this embodiment includes the operation signal generation section 20 which generates an operation signal which operates an electronic instrument. The operation signal generated by the operation signal generation section 20 is a signal which causes an electronic instrument to perform a specific operation. The operation signal may be a signal (ON/OFF signal) which controls the ON/OFF state of an electronic instrument or a command signal (operation select signal), for example.

The operation signal generation section 20 generates the operation signal based on the output signal from the vibration detection sensor 10. In this embodiment, the operation signal generation section 20 determines whether or not the output signal from the vibration detection sensor 10 satisfies a predetermined condition, and generates the operation signal when the output signal satisfies the predetermined condition. Specifically, the operation signal generation section 20 generates the operation signal only when specific vibrations are applied to a building or the like.

The operation signal generation section 20 may determine the presence or absence of a hit input for each of a plurality of switch areas set at different positions of the vibration input area based on the output signal from one vibration detection sensor. When the operation signal generation section 20 has determined that the hit input has been performed for one of the switch areas, the operation signal generation section 20 may generate the operation signal corresponding to that switch area.

The operation signal generation device 1 according to this embodiment may include a plurality of vibration detection sensors 10. The operation signal generation section 20 may determine the presence or absence of a hit input for each of a plurality of switch areas set at different positions of the vibration input area based on a change in the output signal from each of a plurality of vibration detection sensors disposed at different positions. When the operation signal generation section 20 has determined that the hit input has been performed for one of the switch areas, the operation signal generation section 20 may generate the operation signal corresponding to that switch area.

As shown FIG. 1, the operation signal generation section 20 (operation signal generation device 1) according to this embodiment includes a hit count detection section 30. The hit count detection section 30 detects a hit count which is the number of times that the user has hit a building or the like based on the output signal from the vibration detection sensor 10. The hit count detection section 30 receives the output signal from the vibration detection sensor 10 (e.g., digital signal 18 output from the analog processing circuit 15), and determines the hit count based on a change in the output signal. For example, the hit count detection section 30 may be implemented by a CPU or a microcomputer including a CPU.

The hit count detection method for the hit count detection section 30 is not particularly limited. An example of a process in which the hit count detection section 30 detects the hit count is given below taking an example of utilizing a gyrosensor as the vibration detection sensor 10.

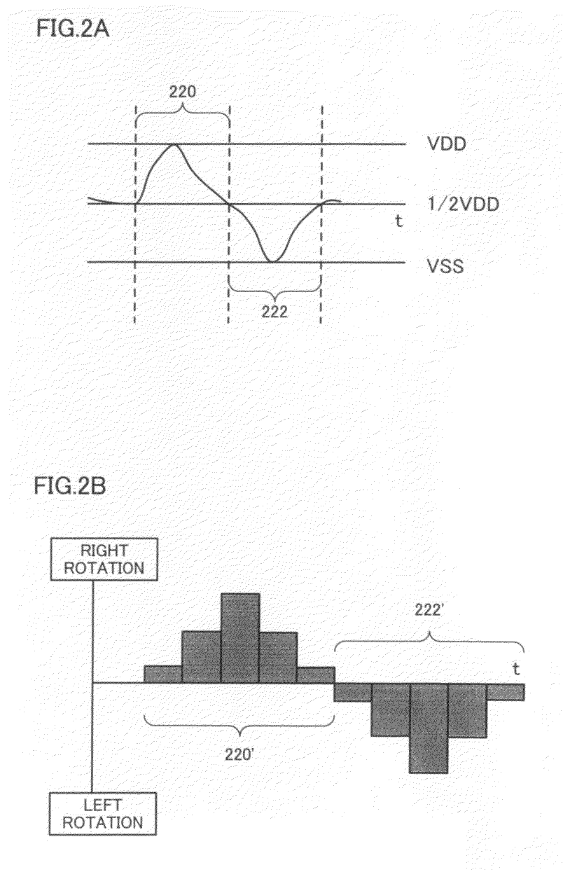

FIG. 2A is a diagram showing the output signal from the vibration detection sensor 10 when the vibration detection sensor 10 (building or the like) vibrates once. When the vibration detection sensor 10 (building or the like) vibrates once, an analog signal (analog voltage signal) shown in FIG. 2A is output from the vibration detection sensor 10. A voltage value 220 shown in FIG. 2A is a voltage value output when the vibration detection sensor 10 is rotated to the right, and a voltage value 222 is a voltage value output when the vibration detection sensor 10 is rotated to the left. The vibration detection sensor 10 displaces to almost the same extent on each side of a predetermined reference axis each time a building or the like vibrates. Therefore, when a building or the like) vibrates once, the vibration detection sensor 10 outputs a signal having two peaks which are symmetrical with respect to a reference voltage, as shown in FIG. 2A.

The analog processing circuit 15 processes the signal to generate a digital signal shown in FIG. 2B. Specifically, FIG. 2B shows a digital conversion result for the analog signal output from the vibration detection sensor 10. When the voltage value in a stationary state is 0, the electronic instrument is rotated to the right in an interval 220′ in which the voltage value is positive (+) (right rotation pulse is generated), and the electronic instrument is rotated to the left in an interval 222′ in which the voltage value is negative (−) (left rotation pulse is generated). When a building or the like has been hit once, a right rotation pulse and a left rotation pulse are detected as a pair. Therefore, it is possible to detect that the building or the like has been hit once by detecting the right rotation pulse and the left rotation pulse which make a pair.

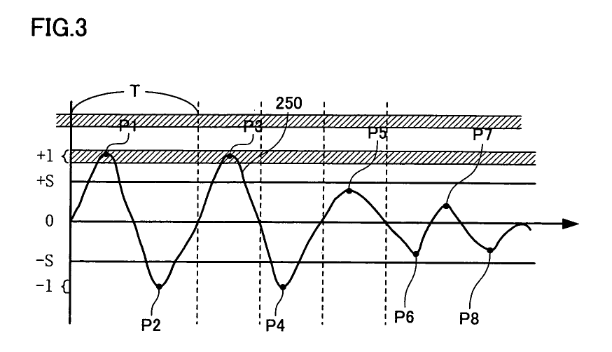

A hit count determination method for the hit count detection section 30 is described below. FIG. 3 is a diagram showing an example of the output signal output from the vibration detection sensor 10 when the vibration detection sensor 10 (building or the like) is hit twice. In FIG. 3, a signal 250 is indicated by a continuous line (analog value). Note that the signal 250 may be indicated by a set of discrete points (digital value).

As shown in FIG. 3, the output signal 250 which indicates the output from the vibration detection sensor 10 has regular pulses having extreme values (maximum value or minimum value) P1, P2, P3, and P4 and derivative pulses having extreme values P5, P6, P7, and P8. The pulses having the extreme values P1 and P2 have occurred due to the first hit operation, and the pulses having the extreme values P3 and P4 have occurred due to the second hit operation. The subsequent irregular pulses (pulses having the extreme values P5, P6, P7, and P8) have occurred due to a shake which occurs as a reaction against the first and second hit operations.

In this embodiment, threshold values (+S1 and −S1) of the strength (voltage value) of the output signal 250 may be set, and it may be determined that one hit operation has been performed when a pair of pulses exceeding the threshold values has been detected. In this case, since the output signal 250 shown in FIG. 3 has two pairs of pulses (a pair of pulses having the extreme values P1 and P2 and a pair of pulses having the extreme values P3 and P4) which exceed the threshold values within a predetermined period, it is determined that two hit operations have been performed. Specifically, the hit count detection section 30 may detect the number of hit operations by counting the number of pulses which appear within a predetermined period.

In this embodiment, extreme value ranges (+1 and −1) which specify the upper limit and the lower limit of the of the strength (voltage value) of the output signal 250 may be set, and it may be determined that one hit operation has been performed when a pair of pulses of which the extreme values are within the extreme value range has been detected. In this case, since the output signal 250 has two pairs of pulses (a pair of pulses having the extreme values P1 and P2 and a pair of pulses having the extreme values P3 and P4) of which the extreme values are within the extreme value range, it is determined that two hit operations have been performed. According to this configuration, a situation can be prevented in which the electronic instrument operates based on vibrations when the vibration detection sensor 10 has output a signal having a value exceeding the extreme value range. This makes it possible to prevent malfunction of the electronic instrument.

In this embodiment, the operation signal generation device 1 may be configured so that a hit operation determination condition (threshold value or extreme value range) can be set. For example, the operation signal generation device 1 may include a rewritable determination condition storage section 32 and a determination condition setting section 34, as shown in FIG. 1. The hit count detection section 30 may detect the hit count based on the determination condition stored in the determination condition storage section 32. The determination condition stored in the determination condition storage section 32 may be set based on the output signal from the vibration detection sensor 10. Specifically, the user may perform a hit operation in a determination condition setting period. The determination conditions such as the threshold value and the extreme value range (value S and value 1) may be set based on the signal output from the vibration detection sensor 10, and stored in the determination condition storage section 32. In this case, the pulse interval (cycle) may also be detected and stored in the determination condition storage section 32.

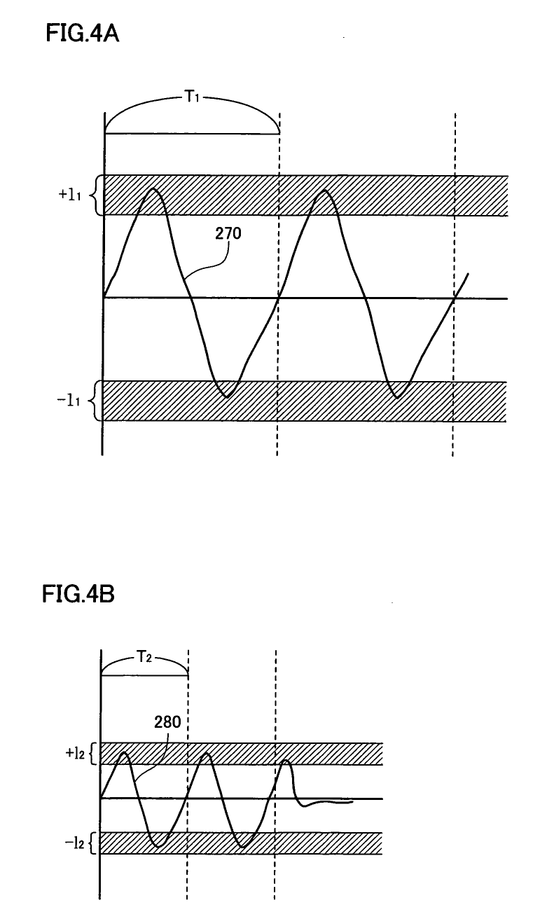

A hit operation (strength and speed) generally depending on each user. FIG. 4A shows an output signal 270 from the vibration detection sensor 10 when a user A has successively performed two hit operations. FIG. 4B shows an output signal 280 from the vibration detection sensor 10 when a user B has successively performed two hit operations. As shown in FIGS. 4A and 4B, the strength and the cycle of the output signal differ depending on the user even if the users have similarly performed two hit operations. Therefore, a situation in which a person other than the user operates the electronic instrument can be prevented by setting a determination condition corresponding to a specific user, whereby the operation signal generation device 1 can be provided with a security function. The output signal from the vibration detection sensor 10 also differs depending on the hit area (operation information input area) of a building or the like. Therefore, if the user arbitrarily sets the hit area within a certain range and the determination condition is set based on the output signal from the vibration detection sensor 10 when the user hits the hit area, it is difficult to generate vibrations which satisfy the determination condition without hitting the hit area. According to this configuration, since it is difficult for a person other than the user to reproduce vibrations which satisfy the determination condition, a reliable security system can be implemented. Moreover, since malfunction of the operation signal generation device 1 can be prevented by setting the determination information for each user, the operation signal generation device 1 can be operated with high accuracy.

As shown FIG. 1, the operation signal generation device 1 according to this embodiment includes a correspondence relationship storage section 40. The correspondence relationship storage section 40 stores the correspondence relationship between the hit count (vibration pattern) and the operation signal. Specifically, the correspondence relationship storage section 40 stores the correspondence relationship between the output signal from the vibration detection sensor 10 and the operation signal. The correspondence relationship storage section 40 may be formed using a rewritable memory such as a flash memory or an EEPROM so that reference data can be set in the rewritable memory based on an external input. The correspondence relationship may be incorporated in an instruction code of a program, and a CPU may execute the program to function as the correspondence relationship storage section 40.

The operation signal generation device 1 according to this embodiment includes an operation signal generation section 25. The operation signal generation section 25 generates an operation signal (command) corresponding to the hit count (i.e., vibration pattern detected by the vibration detection sensor 10) detected by the hit count detection section 30 based on the data which indicates the correspondence relationship stored in the correspondence relationship storage section 40. Therefore, since the desired operation signal can be generated by combining simple hit operations, an operation signal generation device 1 with excellent operability can be provided.

The correspondence relationship storage section 40 may store the correspondence relationship between the output signal (e.g., hit count and vibration pattern) from the vibration detection sensor 10 and the operation signal in units of processing systems. In this case, the operation signal generation device 1 includes a processing system switching section which switches between a plurality of processing systems. The operation signal generation section 20 may generate the operation signal associated with the detected hit count (or vibration pattern) based on the correspondence relationship relating to the selected processing system.

As shown FIG. 1, the operation signal generation device 1 according to this embodiment includes a correspondence relationship setting section 42. The correspondence relationship setting section 42 sets the correspondence relationship between the output signal (hit count and vibration pattern) from the vibration detection sensor 10 and the command, and stores the correspondence relationship in the correspondence relationship storage section 40. For example, the correspondence relationship setting section 42 may be implemented by a CPU or a microcomputer including a CPU.

The operation signal generation device 1 according to this embodiment may include a contact detection section (not shown). The contact detection section may be implemented by an electronic device which can detect contact with the user such as an electrostatic sensor (touch panel), a thermosensor, or a pressure sensor. The operation signal generation device 1 according to this embodiment may be configured so that the electronic instrument can operate only when the user comes into contact with the contact detection section. This prevents a situation in which the electronic instrument malfunctions when the user does not expect that the electronic instrument operates due to the operation signal generation device 1. The contact detection section may be considered to be a means that enables or disables the operation of the electronic instrument based on the output signal from the vibration detection sensor 10. Specifically, the operation signal generation device 1 according to this embodiment may be considered to include a setting means that enables or disables the operation of the electronic instrument based on the output signal from the vibration detection sensor 10. Note that the setting means which may be applied to this embodiment is not limited to the contact detection device.

The operation signal generation device 1 according to this embodiment may be configured so that the operation signal generated by the operation signal generation section 20 is transmitted to the electronic instrument 100 via cable communication or wireless communication. The electronic instrument 100 receives the operation signal, and performs a predetermined operation based on the operation signal. The electronic instrument 100 may include a control section 102. The control section 102 may cause the electronic instrument 100 to perform a predetermined operation based on the operation signal. The control section 102 may be a device which executes a command based on the operation signal. For example, the control section 102 may be implemented by a CPU or a microcomputer including a CPU.

Each function of the operation signal generation device 1 according to this embodiment may be implemented by a semiconductor integrated circuit device (IC). For example, the operation signal generation section 20, the hit count detection section 30, the correspondence relationship storage section 40, and the correspondence relationship setting section 42 may be implemented by a semiconductor integrated circuit device. The vibration detection sensor 10 may be configured as an MEMS which includes a vibration sensing element and a control circuit which controls the operation of the vibration sensing element. The analog processing circuit 15 may be mounted on a semiconductor integrated circuit device which implements the operation signal generation device 1 according to this embodiment, or may be mounted on another semiconductor integrated circuit device, or may be mounted as an electronic component.

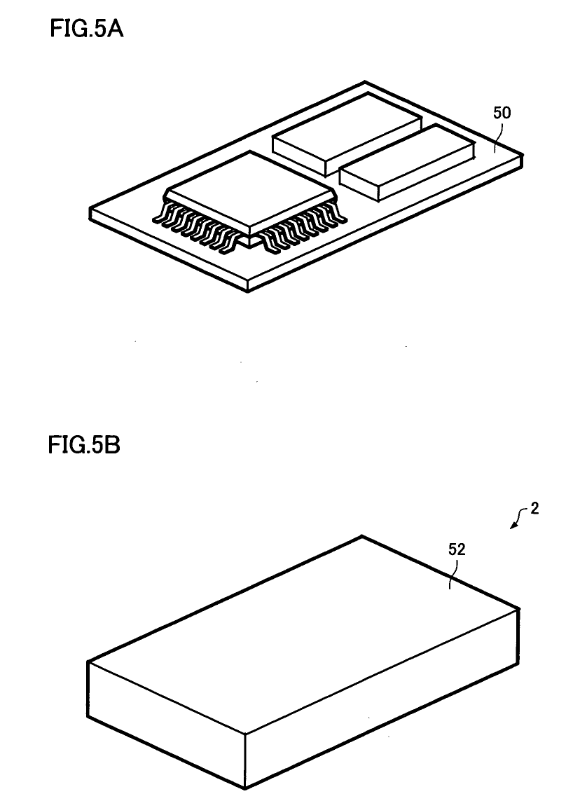

As shown FIG. 5A, the operation signal generation device 1 according to this embodiment includes a board 50 on which at least the vibration detection sensor 10 is mounted. A semiconductor integrated circuit device which implements the functions of the operation signal generation section 20 may be mounted on the board 50. A power supply device and a transmission device which transmits the operation signal to the outside (electronic instrument 100) may be mounted on the board 50. The material and the structure of the board 50 are not particularly limited. The board 50 may have a wiring pattern. The operation signal generation device 1 may transfer various signals through the wiring pattern.

As shown FIG. 5B, the operation signal generation device 1 according to this embodiment includes a housing 52 in which at least the vibration detection sensor 10 is disposed. The board 50 may form part of the housing 52. The circuit surface (mounting surface) of the board 50 and the integrated circuit device (IC) can be disposed in the housing 52 by utilizing the inner surface of the housing 52 as the circuit surface of the board 50. The housing 52 may be a waterproof housing. This prevents the circuit surface of the board 50 and the integrated circuit device from coming into contact with water, whereby an operation signal generation device which can be safely used in a place where water is used or in outdoors can be provided. The housing 52 may be an airtight housing. This provides an operation signal generation device which can be safely used in a flammable environment. In this embodiment, the housing 52 (i.e., the housing 52 and electronic components sealed in the housing 52) may be referred to as an operation signal generation device unit 2.

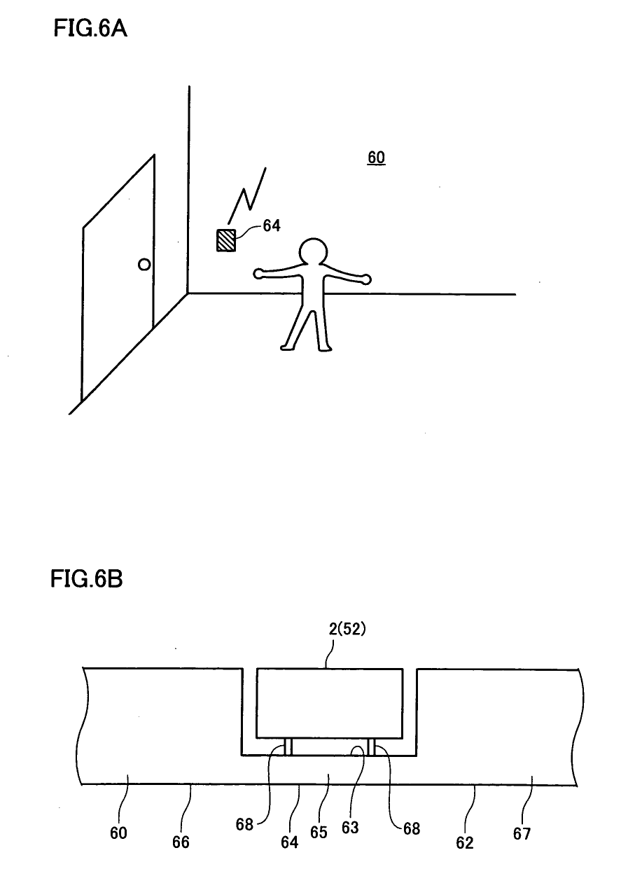

FIGS. 6A and 6B are diagrams showing a state in which the operation signal generation device unit 2 (housing 52) is installed in a holding member 60. The holding member 60 is a member which forms a building or the like. The holding member 60 may be a wall material or a flooring material of a house, for example. The holding member 60 includes a main surface 62 which faces the user. The main surface 62 includes a vibration input area 64 and a peripheral area 66 which surrounds the vibration input area 64. The vibration input area 64 refers to an area in which the operation signal generation device unit 2 is provided on a back surface 63, as shown in FIG. 6B. Specifically, the vibration input area 64 is an area of the main surface 62 which is nearest to the operation signal generation device unit 2 (vibration detection sensor 10). The vibration input area 64 is an area which can most efficiently transmits hit vibrations to the operation signal generation device unit 2.

As shown FIG. 6B, the operation signal generation device unit 2 may be supported by a support member 68. The support member 68 (holding member 60) may support the operation signal generation device unit 2 at one or more points. According to this configuration, since vibrations of the holding member 60 (vibration input area 64) are efficiently transmitted to the operation signal generation device unit 2 (vibration detection sensor 10), an operation signal generation device with high accuracy can be provided. Note that the operation signal generation device unit 2 (board 50) may be held by the holding member 60 using a resin material. Note that vibrations of the holding member 60 can be accurately transmitted to the operation signal generation device unit 2 by attaching the operation signal generation device unit 2 to the holding member through a hard resin material. Note that the operation signal generation device unit 2 (board 50) may be held by the holding member 60 to come into contact with the holding member 60. The vibration detection sensor 10 may contact the holding member 60.

As shown FIG. 6B, holding member 60 may be formed so that the vibration input area 64 and the peripheral area 66 are flat. In the operation signal generation device 1 according to this embodiment, since the operation signal is generated by causing the vibration detection sensor 10 to vibrate, an interface (e.g., switch or touch panel) operated by the user becomes unnecessary. Since the electronic instrument can be operated by transmitting vibrations to the vibration detection sensor 10, the user can operate the electronic instrument even if the user does not accurately identify the position of the operation section (vibration input area 64). Therefore, since it is unnecessary to allow the user to accurately identify the position of the vibration input area 64, a configuration (e.g., elevations or depressions or difference in pattern) recognized by the user need not be provided at the boundary between the vibration input area 64 and the peripheral area 66. Therefore, the operation signal generation device unit 2 can be installed without restrictions on the appearance. In particular, since the operation signal generation device unit 2 can be installed without producing a protrusion on the main surface 62, the operation signal generation device unit 2 can be safely installed under a floor, a road, or the like. The vibration input area 64 may be formed of the same material as that for the peripheral area 66, or may be formed of a material differing from that for the peripheral area 66. The vibration input area 64 may have an arbitrary configuration which can detect contact with the user.

A luminescent coating may be applied to the vibration input area 64. This makes it possible to allow the user to observe the vibration input area 64 in a dark place, whereby the user can accurately operate the electronic instrument even in a dark place.

A component which emits light may be mounted on the board 50 (housing 52), and the vibration input area 64 of the holding member 60 may at least partially transmit light emitted from the component which emits light. This also makes it possible to allow the user to observe the vibration input area 64 in a dark place.

An area 65 of the holding member 60 in which the operation signal generation device unit 2 is installed may be integrally formed with its peripheral area 67. According to this configuration, even if the user hits a wide unspecified area of the holding member 60, the vibrations can be transmitted to the operation signal generation device unit 2 (vibration detection sensor 10). Note that the area 65 of the holding member 60 in which the operation signal generation device unit 2 is installed may be separated from its peripheral area 67. The areas 65 and 67 may be secured using a vibration-absorbing member (e.g., soft resin material). This prevents a situation in which vibrations applied to the peripheral area 67 are transmitted to the area 65 (operation signal generation device unit 2). Therefore, the operation signal generation device which rarely malfunctions can be provided.

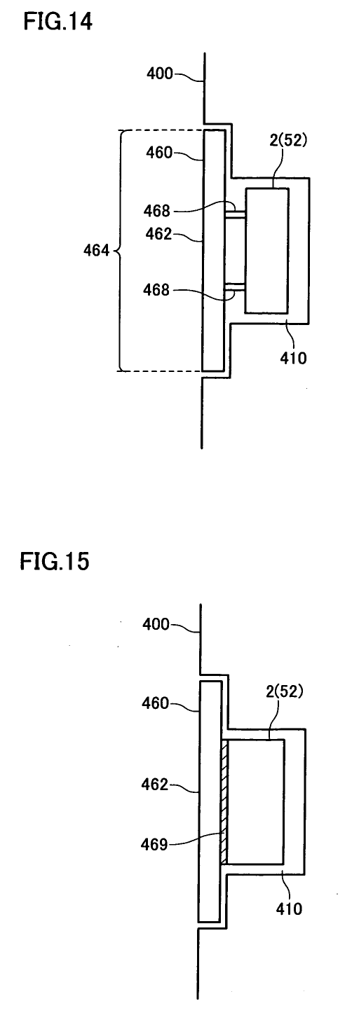

FIGS. 14 and 15 are diagrams showing other examples in which the operation signal generation device unit 2 (housing 52) is installed in a holding member 460. The holding member 460 is fitted into an opening of a depression 410 formed in a building or the like 400 and is integrated with the building or the like 400. The outer surface (main surface 462 which faces the user) of the holding member 460 serves as a vibration input area 464.

As shown FIG. 14, the operation signal generation device unit 2 may be supported by a support member 468. The support member 468 (holding member 460) may support the operation signal generation device unit 2 at one or more points. According to this configuration, since vibrations of the holding member 460 (vibration input area 464) are efficiently transmitted to the operation signal generation device unit 2 (vibration detection sensor 10), an operation signal generation device with high accuracy can be provided.

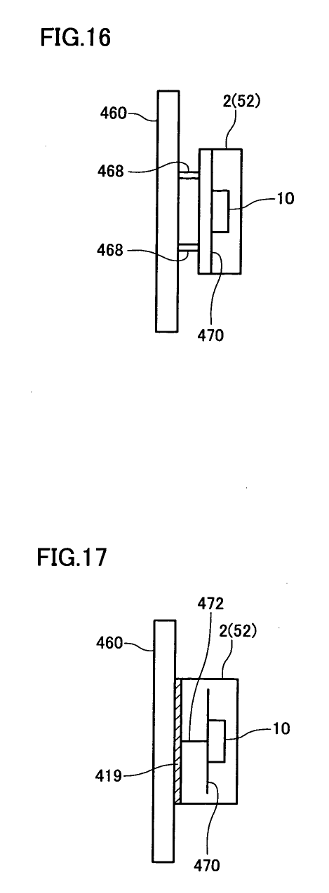

In this case, a board 470 secured on the housing 52 may be provided in the operation signal generation device unit 2, as shown in FIG. 16. The vibration detection sensor 10 may be provided on the board 470. Specifically, vibrations (hit input) applied to the vibration input area 464 are transmitted to the operation signal generation device unit 2 through a support member 468 so that the operation signal generation device unit 2 vibrates, and the vibrations of the operation signal generation device unit 2 are transmitted to the vibration detection sensor 10.

As shown in FIG. 15, the operation signal generation device unit 2 (board 50) may be held by the holding member 460 using a resin material 469.

In this case, a board 470′ connected to the housing 52 by a support member 472 may be provided in the operation signal generation device unit 2, as shown in FIG. 17. The vibration detection sensor 10 may be provided on the board 470′. Specifically, vibrations (hit input) applied to the vibration input area 464 are transmitted to the board 470′ through the support member 472 in the operation signal generation device unit 2, and are transmitted to the vibration detection sensor 10.

Specific operations of the operation signal generation device 1 and the electronic instrument 100 according to this embodiment are described below while giving an example of the correspondence relationship between the hit count and the operation signal.

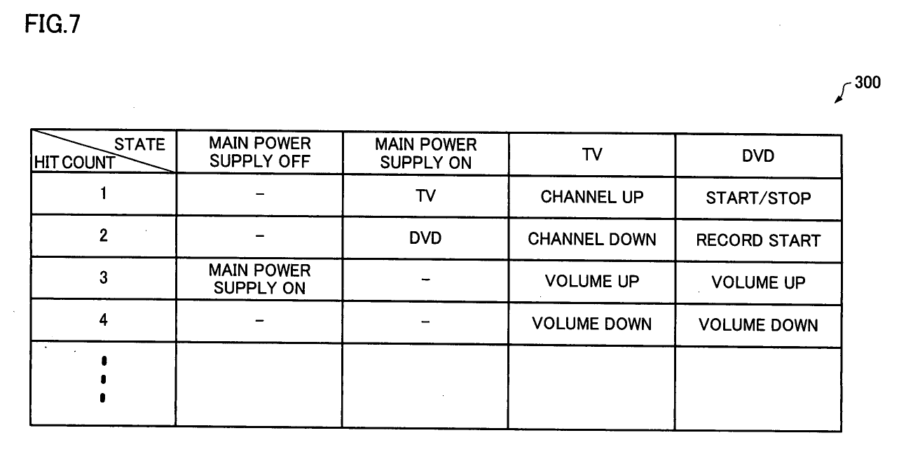

FIG. 7 shows a correspondence table 300 which indicates the correspondence relationship between the hit count and the operation signal when the operation signal generation device 1 is configured as a controller for an AV apparatus (TV including a DVD player). The correspondence table 300 stores the hit count and operation signal identification information which specifies the operation signal corresponding to the hit count. The correspondence table 300 shown in FIG. 7 is a correspondence table when the operation signal generation device 1 has a plurality of processing systems. In this case, the operation signal generation device 1 may include a register which stores information that indicates the selected processing system. The correspondence table of a specific processing system is selected based on the information stored in the register, and the operation signal is generated.

For example, ‘1’ is stored in the register when the main power supply is turned OFF, and an operation signal “main power supply: ON” is allocated to a hit count “3”. ‘2’ is stored in the register when the main power supply has been turned ON. An operation signal which selects a TV and an operation signal that selects a DVD are respectively allocated to a hit count “1” and a hit count “2”. ‘3’ is stored in the register when a TV has been selected. A channel-up operation signal, a channel-down operation signal, a volume-up operation signal, and a volume-down operation signal are respectively allocated to a hit count “1”, a hit count “2”, a hit count “3”, and a hit count “4”. ‘4’ is stored in the register when a DVD has been selected. A start/stop operation signal, a record start operation signal, a volume-up operation signal, and a volume-down operation signal are respectively allocated to a hit count “1”, a hit count “2”, a hit count “3”, and a hit count “4”.

When the operation signal generation device 1 has a plurality of processing systems, as described above, the operability of the electronic instrument can be improved by selecting the processing system.

Note that the operation signal generation device 1 may be configured as a more simple device which detects hit vibrations and outputs an ON/OFF signal. For example, in the case where the electronic instrument is configured as a lighting apparatus, when the vibration detection sensor 10 has detected hit vibrations when the lighting device is turned OFF, the operation signal generation device 1 may generate a light-on operation signal. On the other hand, when the vibration detection sensor 10 has detected hit vibrations when the lighting device is turned ON, the operation signal generation device 1 may generate a light-off operation signal.

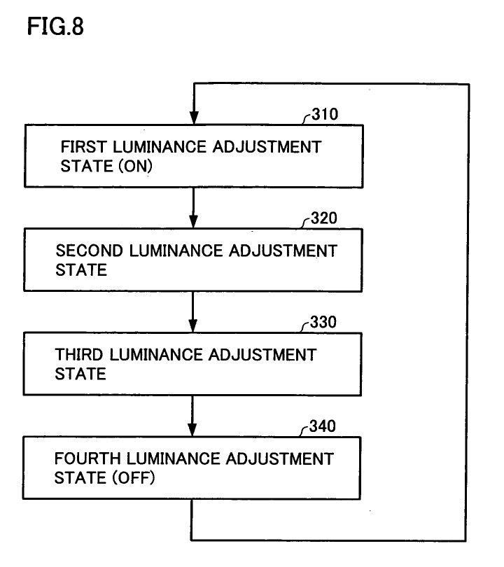

The operation signal generation device 1 may transmit the operation signal to the lighting apparatus each time the hit vibration is input to the vibration detection sensor 10. The lighting apparatus may be set in a first luminance adjustment state (ON: high light intensity) 310, a second luminance adjustment state (medium light intensity) 320, a third luminance adjustment state (low light intensity) 330, and a fourth luminance adjustment state (OFF) 340 in that order each time the operation signal is received, as shown in FIG. 8.

A lighting apparatus as the electronic instrument 100 may be turned ON each time the operation signal is received, and may be turned OFF when a predetermined period of time has expired.

Each process performed by the operation signal generation device 1 according to this embodiment is described below with reference to flowcharts.

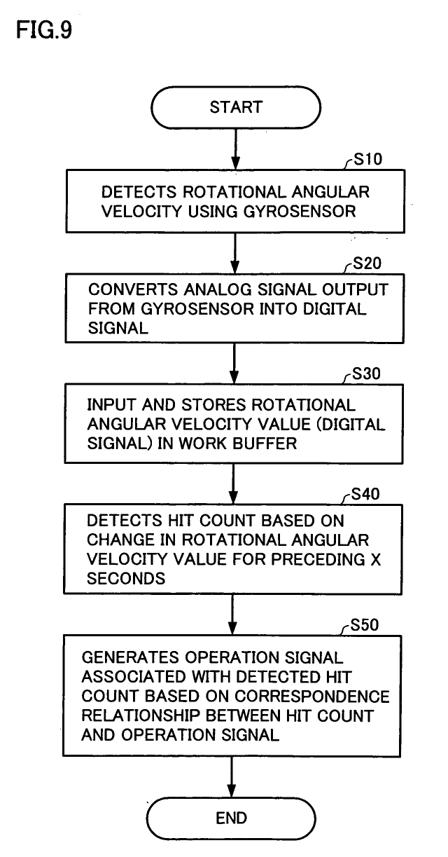

FIG. 9 is a flowchart illustrative of the flow of a process which determines the hit count using a rotational angular velocity.

A rotational angular velocity is detected using the gyrosensor (vibration detection sensor 10) (step S10).

An analog signal output from the gyrosensor is then converted into a digital signal (step S20).

The rotational angular velocity value (digital signal) is input to and stored in a work buffer (step S30).

The hit count is then detected based on a change in the rotational angular velocity value for the preceding x seconds stored in a work buffer (input data storage section) (step S40).

An operation signal associated with the detected hit count is then generated based on the correspondence relationship between the hit count and the operation signal (step S50).

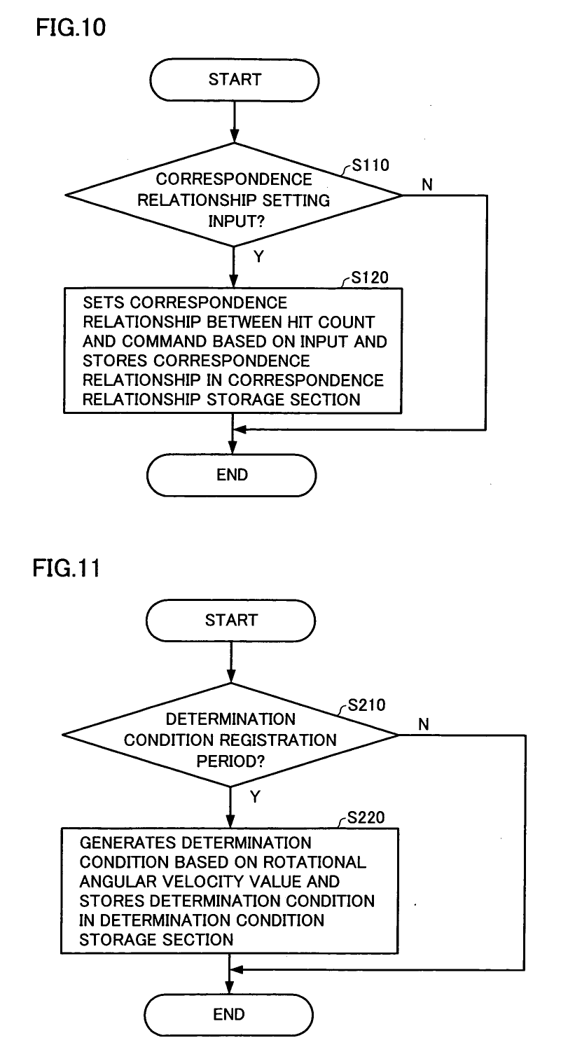

FIG. 10 is a flowchart illustrative of the flow of a process which registers the correspondence relationship between the hit count and the operation signal.

When a correspondence relationship setting input has been received (step S110), the correspondence relationship between the hit count and the command (operation signal) is set based on the input, and stored in the correspondence relationship storage section (step S120).

The correspondence relationship may be input using the following method. For example, when the user has selected an item “correspondence relationship registration”, a selection screen is displayed which prompts the user to select “hit count” or “corresponding command”, and the user's selection is then accepted.

The relationship between the hit count and the execution target command can be configured to be set/changed at any time.

FIG. 11 is a flowchart illustrative of a process which registers the determination condition in the determination condition storage section.

Whether or not the determination condition registration period is occurring is determined. When the determination condition registration period is occurring, the following process is performed (step S210). Whether or not the determination condition registration period is occurring may be determined by determining whether or not the contact detection section has detected contact. For example, determination condition registration may be accepted only when the contact detection section has detected contact with the user.

The determination condition is generated based on the signal (rotational angular velocity value) received within the hit determination condition registration period, and stored in the determination condition storage section (step S220).

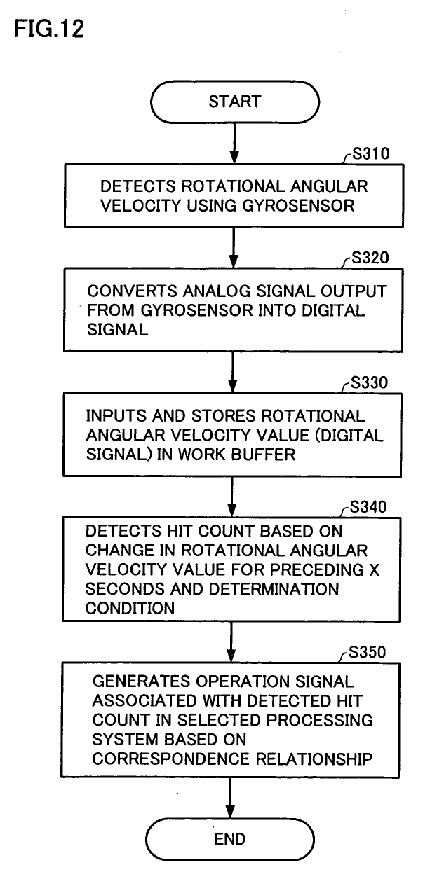

FIG. 12 is a flowchart illustrative of the flow of a process which determines the hit count.

A rotational angular velocity is detected using the gyrosensor (vibration detection sensor) (step S310).

An analog signal output from the gyrosensor is then converted into a digital signal (step S320).

The rotational angular velocity value (digital signal) is input to and stored in the work buffer (step S330).

Specifically, the hit count is detected based on a change in rotational angular velocity value for the preceding x seconds stored in the work buffer and the determination condition (step S340).

An operation signal associated with the hit count in the selected processing system is then generated based on the correspondence relationship stored in the correspondence relationship storage section (step S350).

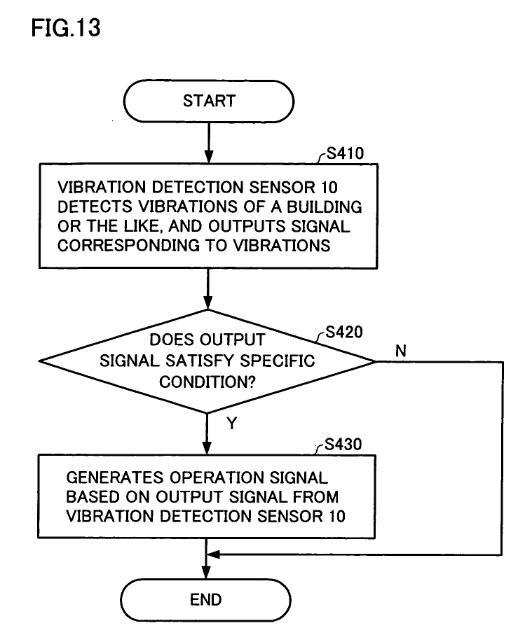

FIG. 13 is a flowchart illustrative of the operation of the operation signal generation device.

The vibration detection sensor 10 detects vibrations, and outputs a signal corresponding to the vibrations (step S410).

Whether or not the output signal from the vibration detection sensor 10 satisfies a predetermined condition is determined (step S420). In this case, whether or not the vibrations of the vibration detection sensor 10 are hit vibrations may be determined.

When the output signal from the vibration detection sensor 10 satisfies a predetermined condition (Yes in step S420), the operation signal is generated based on the signal (step S430). For example, the hit count may be detected, and the operation signal corresponding to the hit count may be generated.

An example in which a plurality of switch areas are provided in the vibration input area and the operation signal corresponding to the switch area is generated is described below.

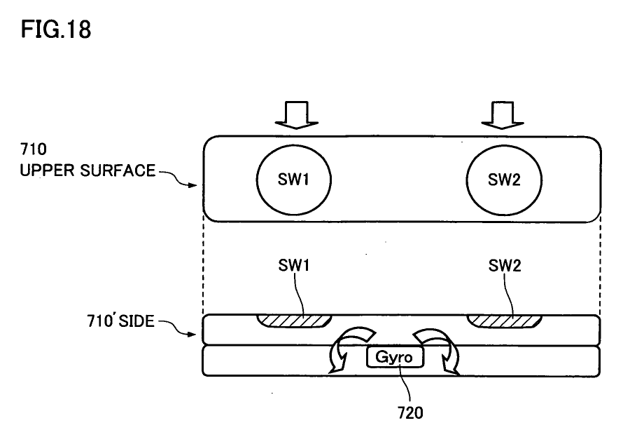

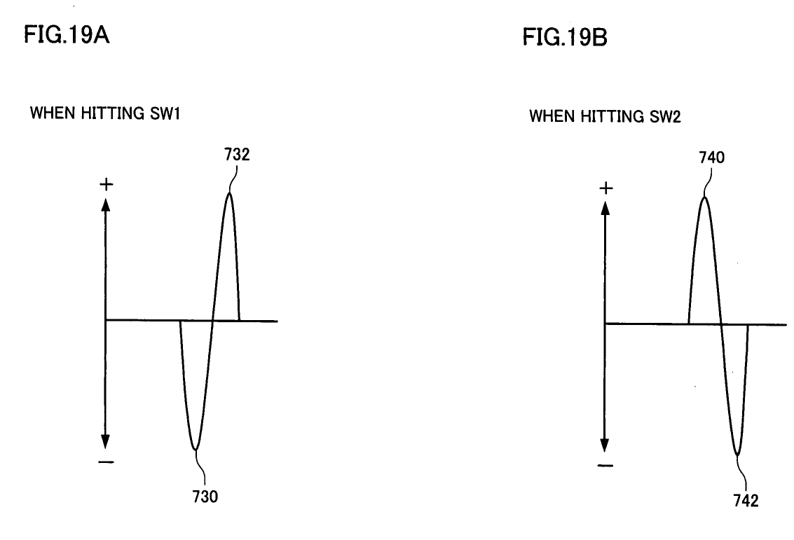

An example in which s hit input performed for each of two different switch areas is determined using one gyrosensor (example of vibration detection sensor) is described below. FIG. 18 is a diagram showing the positional relationship between a plurality of switch areas and a gyrosensor provided in an vibration input area of a building or the like. FIGS. 19A and 19B are diagrams showing examples of an analog signal output from the gyrosensor when hitting each switch area.

The term “switch area” used herein refers to an area which is hit when the user performs a hit input for the vibration input area. The switch area may be appropriately set on the surface of the vibration input area.

In FIG. 18, reference numeral 710 indicates the positional relationship between two switch areas SW1 and SW2 provided in the vibration input area when viewed from the upper side, and reference numeral 710′ indicates the positional relationship between the switch areas SW1 and SW2 provided in the vibration input area and a gyrosensor 710 when viewed from the side.

In this case, since the rotation direction of the gyrosensor 770 differs depending on the hit position, a different analog signal is output depending on the hit position.

FIG. 19A shows an example of an analog signal output from the gyrosensor when hitting the switch area SW1, and FIG. 19B shows an example of an analog signal output from the gyrosensor when hitting the switch area SW2. When the switch area SW1 has been hit, a negative pulse 730 with a predetermined amplitude and a positive pulse 732 with a predetermined amplitude are generated in that order (pulses 730 and 732 make a pair). When the switch area SW2 has been hit, a positive pulse 740 with a predetermined amplitude and a negative pulse 742 with a predetermined amplitude are generated in that order (pulses 740 and 742 make a pair).

Since the characteristics (e.g., change in the amplitude direction) of the analog signal obtained differ depending on the positional relationship between the gyrosensor 720 and the switch areas SW1 and SW2, the switch area which has been hit can be determined from the characteristics of the analog signal. For example, when the analog signal indicates that the negative pulse 730 with a predetermined amplitude and the positive pulse 732 with a predetermined amplitude are generated in that order, as shown in FIG. 19A, it may be determined that the hit input has been performed using the switch area SW1. When the analog signal indicates that the positive pulse 740 with a predetermined amplitude and the negative pulse 742 with a predetermined amplitude are generated in that order, as shown in FIG. 19B, it may be determined that the hit input has been performed using the switch area SW2.

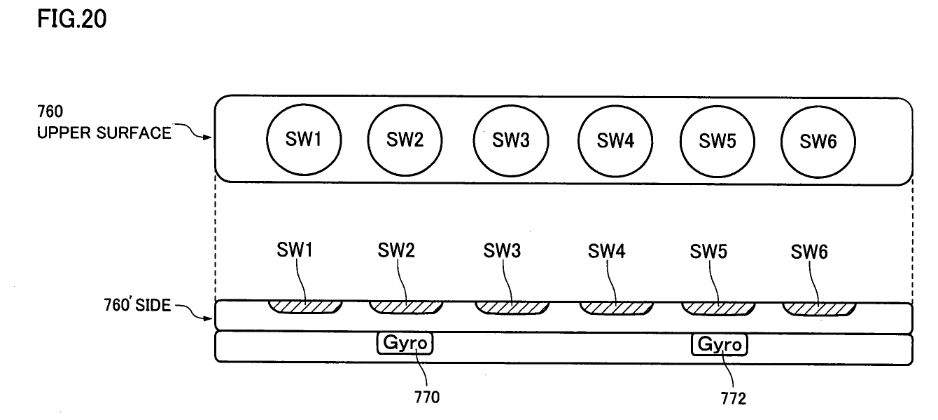

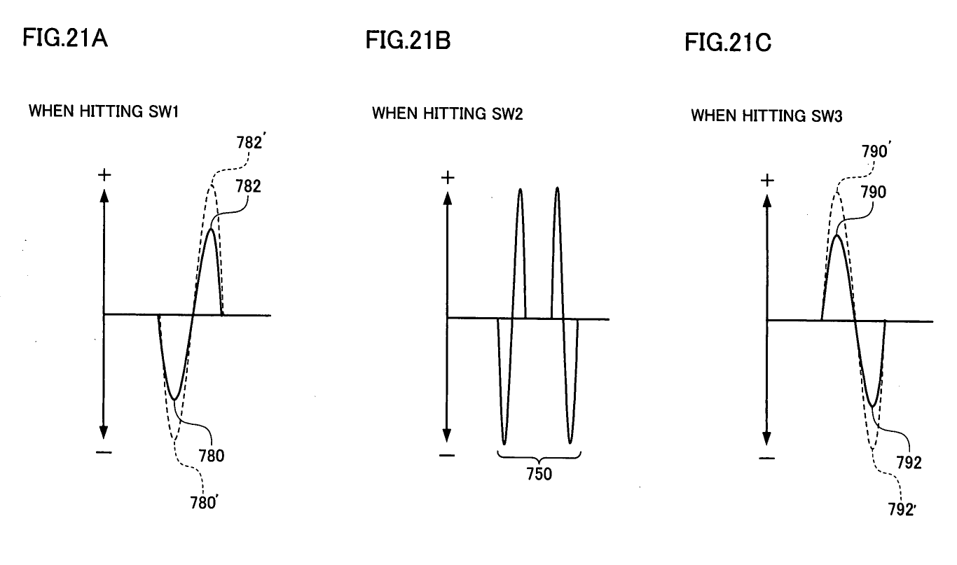

An example of determining the hit inputs using three different switch areas using one gyrosensor is described below. FIG. 20 is a diagram showing the positional relationship between a plurality of switch areas provided in the vibration input area and a gyrosensor. FIGS. 21A to 21C are diagrams showing examples of an analog signal output from the gyrosensor when hitting each switch area.

The term “switch area” used herein refers to an area which is hit when the user performs a hit input for a building or the like. The switch area may be appropriately set on the surface of the vibration input area.

In FIG. 20, reference numeral 760 indicates the positional relationship between three switch areas SW1 to SW3 provided in the vibration input area when viewed from the upper side, and reference numeral 760′ indicates the positional relationship between the switch areas SW1 to SW3 provided in the vibration input area and a gyrosensor 770 when viewed from the side.

In this case, since the rotation direction of the gyrosensor 770 differs depending on the hit position, an analog signal which differs depending on the hit position is obtained.

FIG. 21A shows an example of an analog signal output from the gyrosensor when hitting the switch area SW1, FIG. 21B shows an example of an analog signal output from the gyrosensor when hitting the switch area SW2, and FIG. 21C shows an example of an analog signal output from the gyrosensor when hitting the switch area SW3. When the switch area SW1 has been hit, a negative pulse 780 with a predetermined amplitude and a positive pulse 782 with a predetermined amplitude are generated in that order (pulses 780 and 782 make a pair). The pulses 780 and 782 have an amplitude smaller to some extent than those of reference pulses 780′ and 782′. When the switch area SW3 has been hit, a positive pulse 790 with a predetermined amplitude and a negative pulse 792 with a predetermined amplitude are generated in that order (pulses 790 and 792 make a pair). The pulses 790 and 792 have an amplitude smaller to some extent than those of reference pulses 790′ and 792′. When the switch area SW2 has been hit, a symmetrical amplitude (unspecified amplitude) 750 is generated.

When the switch areas SW4 to SW6 have been hit, a signal is not output from the gyrosensor 770 since a rotational motion does not occur in the gyrosensor 770 even if vibrations are transmitted. Since a rotational motion occurs in a gyrosensor 772 when the switch areas SW4 to SW6 have been hit, whether or not the switch areas SW4 to SW6 have been hit may be determined based on an analog signal from the gyrosensor 772.

Since the characteristics (e.g., change in the amplitude direction or amplitude) of the analog signal obtained differ depending on the positional relationship between the gyrosensor 770 and the switch areas SW1 to SW3, the switch area which has been hit can be determined from the characteristics of the analog signal. For example, when the analog signal indicates that the negative pulse 780 with a predetermined amplitude (pulse of which the amplitude is smaller than the reference pulse) and the positive pulse 782 with a predetermined amplitude (pulse of which the amplitude is smaller than the reference pulse) are generated in that order (pulses 780 and 782 make a pair), as shown in FIG. 21A, it may be determined that a hit input has been performed using the switch area SW1. For example, when the analog signal indicates that the positive pulse 790 with a predetermined amplitude (pulse of which the amplitude is smaller than that of the reference pulse) and the negative pulse 792 with a predetermined amplitude (pulse of which the amplitude is smaller than that of the reference pulse) are generated in that order (pulses 790 and 792 make a pair), as shown in FIG. 21C, it may be determined that a hit input has been performed using the switch area SW3. For example, when the analog signal indicates that the symmetrical amplitude (unspecified amplitude) 750 of which the amplitude is the same as that of the reference pulse is generated as indicated in FIG. 21B, it may be determined that a hit input has been performed using the switch area SW2.

An example in which a hit input is detected in a state in which the gyrosensors and the switch areas are disposed on a flat surface is described below.

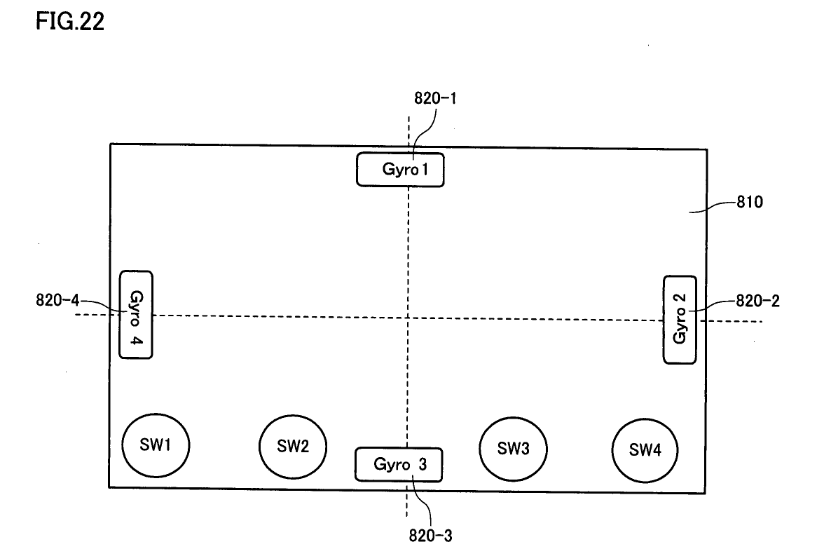

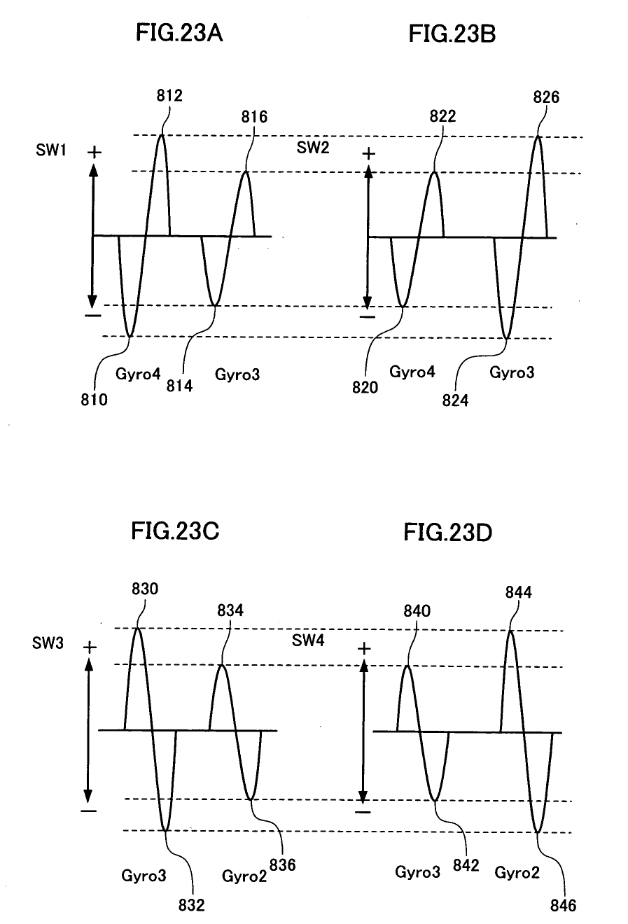

FIG. 22 is a diagram showing the positional relationship between a plurality of switch areas and a plurality of gyrosensor in a vibration input area provided on a flat surface of a building or the like. FIGS. 23A to 23D are diagrams showing examples of an analog signal output from the gyrosensors when hitting each switch area.

The term “switch area” used herein refers to an area which is hit when the user performs a hit input for a building or the like. The switch area may be appropriately set in the vibration input area provided on a flat surface of a building or the like.

FIG. 22 is a diagram showing the positional relationship between four switch areas SW1 to SW4 and four gyrosensors 820-1 to 820-4 in a vibration input area provided on a flat surface 810 of a building or the like.

In this case, the rotation direction and the amplitude of each of the gyrosensors 820-1 to 820-4 differ depending on the hit position.

FIG. 23A shows examples of analog signals output from the gyrosensor 4 (820-4) and the gyrosensor 3 (820-3) when hitting the switch area SW1. When the switch area SW1 has been hit, a negative pulse 810 with a first amplitude and a positive pulse 812 with the first amplitude are generated in that order (pulses 810 and 812 make a pair) from the gyrosensor 4 (820-4; left position near the switch area SW1).

A negative pulse 814 with a second amplitude and a positive pulse 816 with the second amplitude (of which the amplitude is smaller than those of the pulses 810 and 812) are generated in that order (pulses 814 and 816 make a pair) from the gyrosensor 3 (820-3; right position apart from the switch area SW1).

The direction of the waveform is appropriately adjusted by the installation direction when mounting the gyrosensor on a board. For example, when it is desired to cause analog signals in the same direction to be output from the gyrosensor 4 (820-4) and the gyrosensor 3 (820-3) when hitting the switch area SW1, the installation direction of the gyrosensors may be adjusted so that signals in the same direction are output.

FIG. 23B shows examples of analog signals output from the gyrosensor 4 (820-4) and the gyrosensor 3 (820-3) when hitting the switch area SW2. When the switch area SW2 has been hit, a negative pulse 820 with the second amplitude and a positive pulse 822 with the second amplitude are generated in that order (pulses 820 and 822 make a pair) from the gyrosensor 4 (820-4; left position apart from the switch area SW2).

A negative pulse 824 with the first amplitude and a positive pulse 826 with the first amplitude (of which the amplitude is larger than those of the pulses 820 and 822) are generated in that order (pulses 824 and 826 make a pair) from the gyrosensor 3 (820-3; right position near the switch area SW2).

FIG. 23C shows examples of analog signals output from the gyrosensor 3 (820-3) and the gyrosensor 2 (820-2) when hitting the switch area SW3. When the switch area SW3 has been hit, a positive pulse 830 with the first amplitude and a negative pulse 832 with the first amplitude are generated in that order (pulses 830 and 832 make a pair) from the gyrosensor 3 (820-3; left position near the switch area SW3). A positive pulse 834 with the second amplitude (smaller than the first amplitude) and a negative pulse 836 with the second amplitude (of which the amplitude is smaller than those of the pulses 830 and 832) are generated in that order (pulses 834 and 836 make a pair) from the gyrosensor 2 (820-2; right position apart from the switch area SW3).

FIG. 23D shows examples of analog signals output from the gyrosensor 3 (820-3) and the gyrosensor 2 (820-2) when hitting the switch area SW4. When the switch area SW4 has been hit, a positive pulse 840 with the second amplitude and a negative pulse 842 with the second amplitude are generated in that order (pulses 840 and 842 make a pair) from the gyrosensor 3 (820-3; left position apart from the switch area SW4). A positive pulse 844 with the first amplitude (smaller than the second amplitude) and a negative pulse 846 with the first amplitude (of which the amplitude is larger than those of the pulses 840 and 842) are generated in that order (pulses 844 and 846 make a pair) from the gyrosensor 2 (820-2; right position near the switch area SW4).

Since the amplitude directions (including the generation order of positive and negative pulses) and the amplitudes of the analog signals output from the gyrosensors differ depending on the switch area to be hit, the hit switch area can be determined based on the amplitude directions (including the generation order of positive and negative pulses) and the amplitudes of the analog signals output from the gyrosensors.

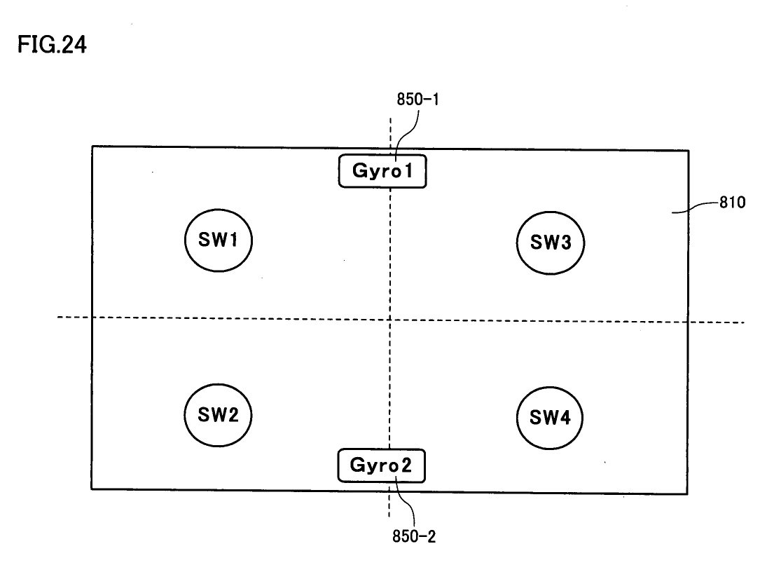

FIG. 24 is a diagram showing the positional relationship between four switch areas SW1 to SW4 and two gyrosensors 850-1 and 850-2 in a vibration input area 4 provided on a flat surface 810 of a building or the like.

In this case, the rotation direction and the amplitude of each of the gyrosensors 850-1 and 850-2 differ depending on the hit position.

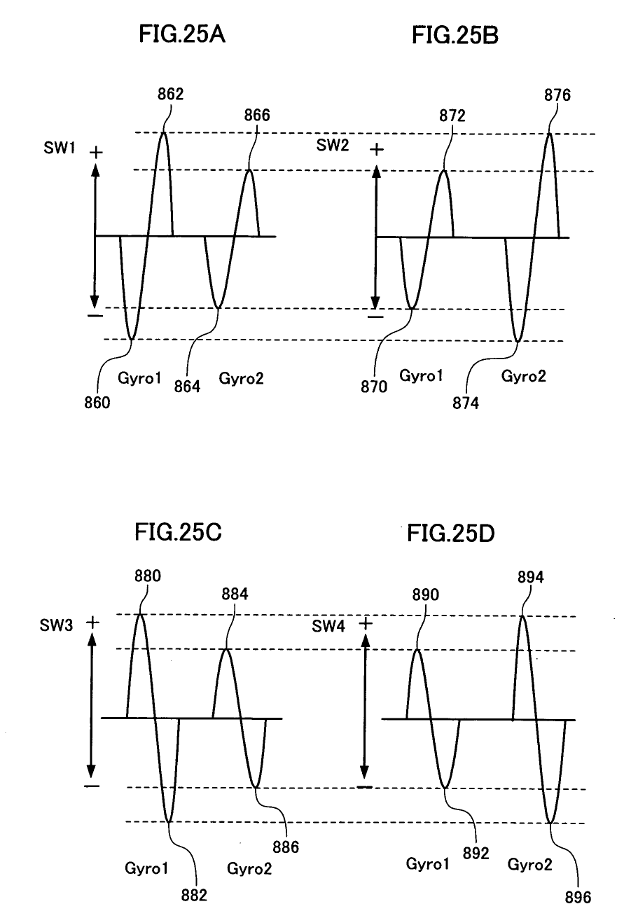

FIG. 25A shows examples of analog signals output from the gyrosensor 1 (850-1) and the gyrosensor 2 (850-2) when hitting the switch area SW1. When the switch area SW1 has been hit, a negative pulse 860 with the first amplitude and a positive pulse 862 with the first amplitude are generated in that order (pulses 860 and 862 make a pair) from the gyrosensor 1 (850-1; right position near the switch area SW1). A negative pulse 864 with the second amplitude (smaller than first amplitude) and a positive pulse 866 with the second amplitude (of which the amplitude is smaller than those of the pulses 810 and 812) are generated in that order (pulses 864 and 866 make a pair) from the gyrosensor 2 (850-2; right position apart from the switch area SW1).

FIG. 25B shows examples of analog signals obtained from the gyrosensor 1 (850-1) and the gyrosensor 2 (850-2) when hitting the switch area SW2. When the switch area SW2 has been hit, a negative pulse 870 with the second amplitude and a positive pulse 872 with the second amplitude are generated in that order (pulses 870 and 872 make a pair) from the gyrosensor 1 (850-1; right position apart from the switch area SW2). A negative pulse 874 with the first amplitude (smaller than second amplitude) and a positive pulse 876 with the first amplitude (of which the amplitude is smaller than those of the pulses 870 and 872) are generated in that order (pulses 874 and 876 make a pair) from the gyrosensor 2 (850-2; right position near the switch area SW2).

FIG. 25C shows examples of analog signals obtained from the gyrosensor 1 (850-1) and the gyrosensor 2 (850-2) when hitting the switch area SW3. When the switch area SW3 has been hit, a positive pulse 880 with the first amplitude and a negative pulse 882 with the first amplitude are generated in that order (pulses 880 and 882 make a pair) from the gyrosensor 1 (850-1; left position near the switch area SW3). A positive pulse 884 with the second amplitude (smaller than those of the first amplitude) and a negative pulse 886 with the second amplitude (of which the amplitude is smaller than those of the pulses 880 and 882) are generated in that order (pulses 884 and 886 make a pair) from the gyrosensor 2 (820-2; left position apart from the switch area SW3).

FIG. 25D shows examples of analog signals obtained from the gyrosensor 1 (850-1) and the gyrosensor 2 (850-2) when hitting the switch area SW4. When the switch area SW4 has been hit, a positive pulse 890 with the second amplitude and a negative pulse 892 with the second amplitude are generated in that order (pulses 890 and 892 make a pair) from the gyrosensor 1 (850-1; left position apart from the switch area SW4). A positive pulse 894 with the first amplitude (smaller than the second amplitude) and a negative pulse 896 with the first amplitude (of which the amplitude is larger than those of the pulses 890 and 892) are generated in that order (pulses 894 and 896 make a pair) from the gyrosensor 2 (820-2; left position near the switch area SW4).

When the arrangement relationship between the gyrosensor and the switch area is changed, the characteristics (e.g., amplitude direction and amplitude) of the analog signal used to determine whether or not each switch area has been hit differ. Therefore, the characteristics of the analog signals output from the gyrosensors when hitting each switch area may be determined in advance corresponding to the arrangement relationship between the gyrosensors and the switch areas, and a condition used to determine the hit switch area may be set.

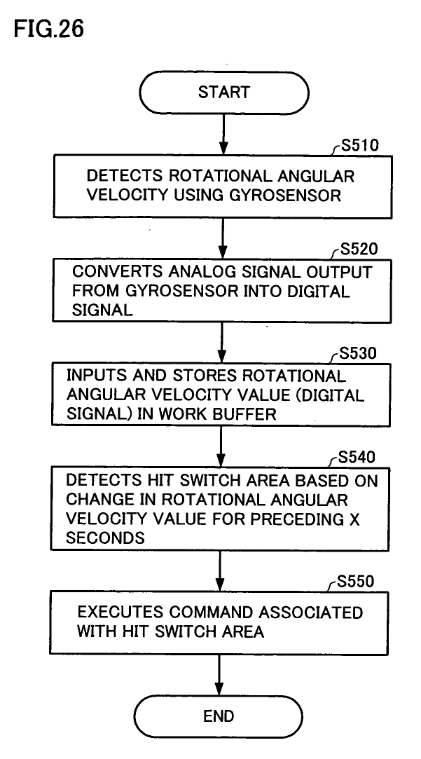

FIG. 26 is a flowchart illustrative of the flow of a process which determines the presence or absence of a hit input for a vibration input area of a building utilizing a rotational angular velocity.

A rotational angular velocity is detected using the gyrosensor (step S510).

An analog signal output from the gyrosensor is then converted into a digital signal (step S520).

The rotational angular velocity value (digital signal) is input to and stored in the work buffer (step S530).

The switch area which has been hit is determined based on a change in rotational angular velocity value for the preceding x seconds stored in the work buffer (input data storage section) (step S540). The switch area may be determined based on a change in the amplitude direction of the analog signal (or digital signal obtained by subjecting the analog signal to A/D conversion) output from one gyrosensor, as described with reference to FIGS. 19A and 19B, or may be determined based on a change in the amplitude direction and the amplitude of the analog signal (or digital signal obtained by subjecting the analog signal to A/D conversion) output from one gyrosensor, as described with reference to FIGS. 21A to 21C, for example. The switch area may be determined based on the combination of changes in the amplitude directions and the amplitudes of the analog signals (or digital signal obtained by subjecting the analog signal to A/D conversion) output from a plurality of gyrosensors, as described with reference to FIGS. 23A to 23D and FIGS. 25A to 25D, for example.

A command associated with the hit switch area is then executed (step S550).

The invention is not limited to the above-described embodiments, and various modifications can be made. For example, the invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

The above embodiments have been given taking an example in which a change in voltage value is output from the vibration detection angular velocity sensor as an analog signal. Note that the invention is not limited thereto. For example, a change in current value may be output from the angular velocity sensor as an analog signal.

For example, the operation signal generation section 20 may include a feature extraction section which extracts the features of vibrations (vibration pattern) instead of, or in addition to, the hit count detection section 30. The operation signal generation section may generate an operation signal corresponding to the vibration pattern of the vibration detection sensor 10 (building or the like) based on the extracted features of the output signal from the vibration detection sensor 10 and the data which indicates the correspondence relationship between the features of the output signal and the operation signal.

In this case, the operation signal can also be accurately generated based on vibrations applied to a building or the like.

The operation signal generation section 20 may generate a trigger signal as the operation signal when the output signal from the vibration detection sensor 10 satisfies a predetermined determination condition. In this case, the control section 102 of the electronic instrument 100 may generate a control signal which controls the operation of the electronic instrument 100 based on the trigger signal. For example, the control section 102 may receive the trigger signal and ON/OFF-control the electronic instrument 100. Alternatively, the control section 102 may receive the trigger signal and sequentially set (change) the operation mode of the electronic instrument.

The operation signal generation section 20 may generate a signal which indicates the hit count determined by the hit count detection section 30 as the operation signal. The electronic instrument 100 (control section 102) may receive the signal which indicates the hit count, and generate a control signal corresponding to the hit count. In this case, the hit count storage section may form part of the control section 102.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An operation signal generation device generating an operation signal for operating an electronic instrument, the operation signal generation device comprising:
a vibration detection sensor which detects vibrations of a building, a constructed product secured on a building, or a stationary article; and
an operation signal generation section which determines whether or not an output signal from the vibration detection sensor satisfies a predetermined condition, and generates the operation signal when the output signal satisfies the predetermined condition.

2. The operation signal generation device as defined in claim 1, further comprising:
a holding member which holds the vibration detection sensor and is able to function as part of the building, the constructed product, or the article.

3. The operation signal generation device as defined in claim 2,
a main surface of the holding member having a vibration input area; and
the vibration input area and a peripheral area of the vibration input area on the main surface being formed flat.

4. The operation signal generation device as defined in claim 2,
the holding member engaging with an opening of a depression formed in the building, the constructed product, or the article so that the holding member is integrated with the building, the constructed product, or the article, an outer surface of the holding member serving as a vibration input area.

5. The operation signal generation device as defined in claim 3,
a fluorescent coating being at least partially applied to the vibration input area.

6. The operation signal generation device as defined in claim 3, further comprising:
a light-emitting component,
the vibration input area at least partially transmitting light emitted from the light-emitting component.

7. The operation signal generation device as defined in claim 1, further comprising:
a board on which the vibration detection sensor is mounted,
the board being disposed at an interval from the holding member.

8. The operation signal generation device as defined in claim 7,
the board being held by the holding member at one or more points.

9. The operation signal generation device as defined in claim 7,
the board being held by the holding member through a resin member.

10. The operation signal generation device as defined in claim 1, further comprising:
a board on which the vibration detection sensor is mounted,
the board being in contact with the holding member.

11. The operation signal generation device as defined in claim 1, further comprising:
a waterproof housing in which at least the vibration detection sensor is disposed.

12. The operation signal generation device as defined in claim 1, further comprising:
an airtight housing in which at least the vibration detection sensor is disposed.

13. The operation signal generation device as defined in claim 1, further comprising:
a determination condition storage section which stores the predetermined condition; and
a determination condition setting section which causes the determination condition storage section to store the predetermined condition based on the output signal from the vibration detection sensor.

14. The operation signal generation device as defined in claim 1,
the operation signal generation section determining whether or not a hit input is performed to the building, the constructed product, or the article based on the output signal from the vibration detection sensor, and generating the operation signal corresponding to the hit input when the operation signal generation section has determined that the hit input has been performed.

15. The operation signal generation device as defined in claim 14,
wherein the operation signal generation section determines whether or not a hit input is performed to a plurality of switch areas respectively set at different positions of the vibration input area based on the output signal from the vibration detection sensor; and
wherein, when the operation signal generation section has determined that the hit input has been performed to a switch area among the switch areas, the operation signal generation section generates the operation signal corresponding to the switch area.

16. The operation signal generation device as defined in claim 14,
wherein the operation signal generation section determines whether or not a hit point is performed to a plurality of switch areas respectively set at different positions of the vibration input area based on change in output signals from a plurality of the vibration detection sensors respectively disposed at different positions of the holding member; and
wherein, when the operation signal generation section has determined that the hit input has been performed to a switch area among the switch areas, the operation signal generation section generates the operation signal corresponding to the switch area.

17. The operation signal generation device as defined in claim 14,
wherein the operation signal generation section includes:
a hit count detection section detecting a hit count which is a number of hits at the building, the constructed product, or the article by a user based on the output signal from the vibration detection sensor; and
a correspondence relationship storage section storing a correspondence relationship between the hit count and the operation signal; and
wherein the operation signal generation section generates the operation signal corresponding to the hit count detected by the hit count detection section based on the correspondence relationship.

18. The operation signal generation device as defined in claim 17, further comprising:
a correspondence relationship setting section which sets the correspondence relationship between the hit count and the operation signal and causes the correspondence relationship storage section to store the correspondence relationship.

19. The operation signal generation device as defined in claim 17,
the correspondence relationship storage section storing the correspondence relationship between the hit count and the operation signal in units of processing systems,
the operation signal generation device further comprising a processing system switching section which selects a processing system from a plurality of processing systems; and
the operation signal generation section generating the operation signal associated with the generated hit count based on the correspondence relationship in the selected processing system.

20. The operation signal generation device as defined in claim 1, further comprising:
a setting means which enables or disables an operation of the electronic instrument based on the output signal from the vibration detection sensor.
